(19) United States
(12) Patent Application Publication
(10) Pub. No.: US 2002/0066750 A1
(43) Pub. Date: Jun. 6, 2002

(54) Device for packaging and dispensing a substance, in particular for hair care

(76) Inventor: Nicolas Albisetti, Paris (FR)

Correspondence Address: OPPENHEIMER WOLFF & DONNELLY LLP, Suite 3800, 2029 Century Park East, Los Angeles, CA, 90067-3028, US

(21) Appl. No.: 09/899,405

(22) Filed: Jul. 5, 2001

(30) Foreign Application Priority Data
Jul. 17, 2000 (FR) 00 09350

(51) Int. Cl. B67D 5/60

(52) U.S. Cl. 222/143

(57) ABSTRACT

The invention relates to a packaging and applicator device comprising a receptacle having a compressible portion and a dispenser endpiece. The device has first and second bearing surfaces situated at respective ends of the compressible portion so as to enable a user to exert pressure along the axis of the receptacle so as to move said bearing surfaces towards each other and compress the compressible portion. The first bearing surface is situated on the endpiece or in the vicinity thereof, so that the user can dispense the substance while holding the device in one hand and bringing said hand into contact with the surface onto which the substance is to be applied.

The present invention relates to devices for packaging and applying a cosmetic and/or care product, and more particularly but not exclusively to devices for applying a substance to the hair and/or the scalp.

### BACKGROUND OF THE INVENTION

Numerous devices are known for packaging two substances separately and for dispensing a mixture thereof.

Those known devices comprise a receptacle having a compressible portion and a dispensing endpiece having an outlet channel opening out to the outside on the axis of the receptacle.

For reasons of cost, the present trend is to use endpieces having a break-off portion for breaking off on first use.

The Applicant company has found that applying a substance to the roots of the hairs, with the endpiece coming into contact with the scalp, can then be uncomfortable since the endpiece can present a sharp edge after the break-off portion has been removed, and this edge can scratch the scalp or catch on hairs.

In addition, it is relatively difficult for a user to control accurately the pressure exerted by the endpiece on the scalp and to follow a predetermined path, e.g. a parting formed between the hairs.

### Object and Summary of the Invention

An object of the present invention is to provide a novel packaging and applicator device that makes it possible to improve comfort during application of the substance and/or to facilitate application thereof along a predetermined path.

In conventional manner, the device of the invention comprises a receptacle having a compressible portion and a dispenser endpiece, the device including first and second bearing surfaces situated respectively at opposite ends of the compressible portion so as to enable a user to exert pressure along the axis of the receptacle to move said bearing surfaces towards each other and compress the compressible portion, the first bearing surface being situated on the endpiece or close thereto, so that the user can dispense the substance by holding the device in one hand and bringing that hand into contact with the surface onto which the substance is to be applied.

By means of the invention, the user can easily control by hand the pressure with which the endpiece is pressed against the surface to be treated.

The user can also easily move the endpiece accurately along the surface to be treated without the endpiece coming into contact therewith, merely with the help of a hand.

Thus, when using a break-off endpiece, it is easier to avoid contact between the endpiece and the surface to be treated.

Advantageously, the compressible portion comprises a bellows thus enabling the user to measure out the quantity of substance that is dispensed during application in a manner that is relatively easy and accurate.

In this case, the second bearing surface is preferably defined by a transverse wall to which the bellows is connected.

The second bearing surface can be formed around a constricted portion of the receptacle defining an annular waist in which the middle and index fingers can be placed during use.

Such a constricted portion serves advantageously to receive a removable plug, so as to form two compartments containing components that are to be mixed together extemporaneously, e.g. two reagents for hair dye.

In general, when two components are used, the plug is disposed in such a manner as to form two compartments each containing one component.

Advantageously, the device includes activation means enabling the plug to be moved on first use so as to enable the components to mix together.

These activation means can be implemented in various ways.

In a particular embodiment, the activation means comprise a rod secured to the dispenser endpiece.

The rod may be arranged to exert thrust on the plug, the plug being placed in the constricted portion of the receptacle so as to be move out therefrom by thrust exerted by the rod.

The rod can also be provided with coupling means suitable for snap-fastening on relief on the plug when the rod is moved close thereto.

The plug is then placed in the constriction so as to be moved out by traction exerted on the rod.

In a particular embodiment, the receptacle is formed by assembling together two containers, one container having a sleeve and the other having a neck suitable for engaging in said sleeve, the plug being positioned therein in such a manner as to be ejected when the two containers are assembled together so as to allow the components to mix together.

It is also possible for the receptacle to be constituted by two containers assembled together so as to be capable of turning relative to each other, and for the device to be arranged in such a manner that turning one of the containers relative to the other causes the plug to be moved and the containers to be put into communication with other.

The plug can also be placed in the above-mentioned constriction so as to be ejected by extra pressure created inside the receptacle by deforming the compressible portion.

The endpiece may include an outlet channel that is off-center and the first bearing surface may be situated on the axis of the receptacle.

The outlet channel can open to the outside in a direction that is substantially parallel to the axis of the receptacle, or in a variant in a direction that is substantially perpendicular thereto.

In a particular embodiment, the device includes an adjustment member enabling the compression stroke of the compressible portion to be modified depending on the amount of substance that is to be dispensed.

The dispenser endpiece is then advantageously carried by the adjustment member.

The endpiece can have a plurality of outlet channels.

In which case, the endpiece advantageously includes a wall defining the first bearing surface situated on the axis of the receptacle.

The dispenser endpiece can also be hinged on the adjustment member and the adjustment member can have a wall enabling the outlet orifice of the endpiece to be masked when the endpiece is in a first position relative to the adjustment member, the endpiece being capable of taking up a second position when the user presses on the first bearing surface, in which second position the outlet orifice is no longer masked by said wall.

In a particular embodiment, the adjustment member includes an outlet orifice surrounding by an annular lip which engages in a housing of the endpiece.

The adjustment member is preferably fixed in adjustable manner on a neck of the receptacle.

The invention also provides the use of a device as specified above, the device being used in the head-down position, i.e. with the endpiece pointing downwards.

The device is preferably used with the thumb pressing on the first bearing surface and with the index and middle fingers pressing against the second bearing surface.

The invention also provides a device for packaging and applying a substance, the device comprising a receptacle having a compressible portion and a dispenser endpiece, the device including first and second surfaces situated respectively at opposite ends of the compressible portion so as to enable a user to exert pressure along the axis of the receptacle to move said surfaces towards each other and compress the compressible portion, wherein the endpiece includes an outlet channel that is off-center and has an axis that is substantially parallel to the axis of the receptacle, and wherein the first surface intersects on the axis of the receptacle.

As mentioned above, the device of the invention is advantageously used for applying a substance to the hair and/or to the scalp.

### BRIEF DESCRIPTION OF THE DRAWINGS

Other characteristics and advantages of the present invention will appear on reading the following detailed description of non-limiting examples and on examining the accompanying drawings, in which:

FIGS. 1 to 3 are diagrammatic axial sections showing a device of the invention for separately packaging two components for mixing together extemporaneously;

FIGS. 4 and 5 show the device in use; and

FIGS. 6 to 13 are diagrammatic axial sections showing variant embodiments.

### MORE DETAILED DESCRIPTION

FIGS. 1 to 3 show a device 1 comprising a receptacle 2 having a bottom container 3 and a top container 4 filled with respective components A and B that are to be mixed together on first use.

The receptacle 2 has a constricted portion 5 through which the bottom and top containers 3 and 4 can communicate.

The receptacle 2 has a constricted portion 5 through which the bottom and top containers 3 and 4 can communicate.

A plug 6 can be received in leakproof manner in the constricted portion 5 to enable the components A and B to be packaged separately prior to first use.

The plug 6 has a transverse wall 8 extending perpendicularly to the axis X of the device 1, and an annular sealing lip 7 shaped to bear in leakproof manner against the radially inner surface of the constricted portion 5.

The lip 7 is connected to the transverse wall 8 so as to be set back a little from its peripheral edge, thereby forming a collar 9.

The plug 6 includes a catch 11 extending along the X axis above the transverse wall 8.

When the plug 6 is in place, the bottom and top containers 3 and 4 cannot communicate with each other.

At its bottom portion, the top container 4 has a transverse wall 12 whose periphery runs into a bellows 14 which is compressible along the X axis.

Where it joins the constricted portion 5, the transverse wall 12 has an annular flat 10 on which the collar 9 of the plug 6 rests when the plug is in place.

The top of the bellows 14 is connected to a neck 16 having a dispenser endpiece 17 fitted thereon.

In the embodiment described, the neck 16 has an outside thread and the endpiece 17 has an assembly skirt 18 with an inside thread suitable for screwing onto the neck 16.

The endpiece 17 also has means for providing sealing with the neck 16.

In the embodiment described, these sealing means are constituted by an annular sealing lip 19 that bears in leakproof manner against the radially inner surface of the neck 16.

The assembly skirt 18 is connected to a top wall 20 of the endpiece having a conical portion 21 defining an outlet channel 22 for the substance, this channel having an axis Y which is parallel with the axis X but which does not coincide therewith.

The conical portion 21 is terminated by a break-off end portion 23.

At the foot of the conical portion 21, the top wall 20 defines a first bearing surface 25 in the meaning of the present invention, whose function is specified below.

A rod 26 on the axis X is connected to the bottom face of the top wall 20.

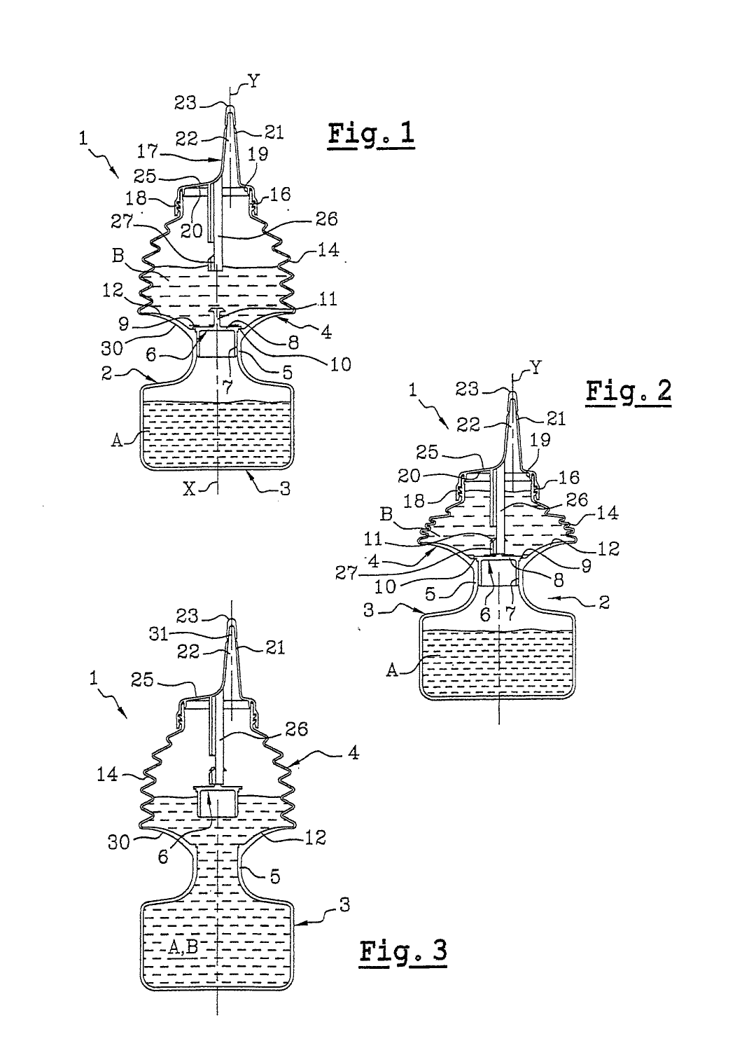

This rod 26 has elastically deformable tabs 27 at its bottom end suitable for snap-fastening onto the catch 11 when the bellows 14 is compressed axially, as shown in FIG. 2.

The rod 26 makes it possible to extract the plug 16 from the constricted portion 5 when the bellows 14 expands on its own under the effect of its own elasticity and the pressure in the top container 4, thereby enabling the components A and B to mix together, as shown in FIG. 3.

It will be observed that the plug 6 remains coupled to the rod 26 so that it does not interfere with dispensing of the mixture.

The outside surface of the transverse wall 12 defines a second bearing surface 30 that is annular.

To use the device 1, the break-off portion 23 is removed and the receptacle 2 is turned upside down.

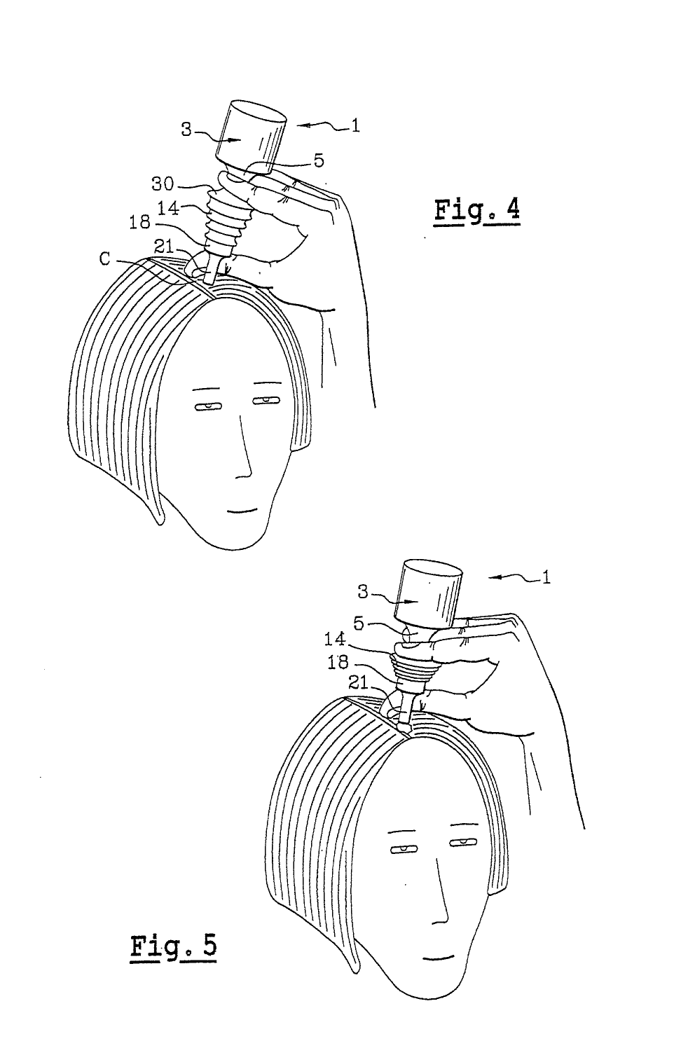

The middle and index fingers are placed around the constricted portion 5 in the annular waist formed between the containers 3 and 4, as can be seen in FIG. 4, while the thumb comes to bear on the surface 25.

The thumb can follow the profile of the head C while also ensuring that the orifice 31 through which the substance is delivered after the break-off portion 23 has been removed is kept at a very small distance above the scalp.

The height of the conical portion 21 is selected in such a manner as to enable the user to hold the orifice 31 above the scalp using the thumb or some other part of the hand.

To dispense the substance, the user compresses the bellows 14 axially, as shown in FIG. 5.

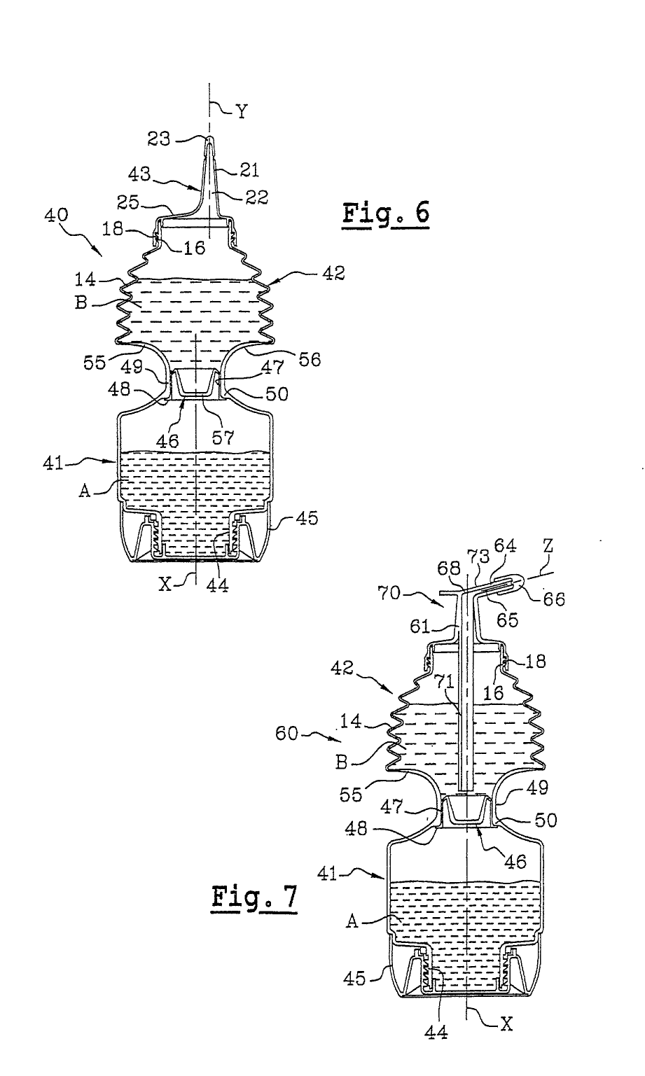

FIGS. 6 to 13 show various other embodiments.

The device 40 shown in FIG. 6 has a bottom container 41, a top container 42, a dispenser endpiece 43, and a constricted portion 49 through which the bottom and top containers 41 and 42 can communicate.

The bottom container 41 differs from the above-described bottom container 3 by the fact that it includes in its bottom portion a sleeve 44 on the axis X onto which a cap 45 is screwed for the purpose of closing the sleeve in leakproof manner.

The above-described plug 6 is replaced by a plug 46 whose periphery includes an annular wall 47 with a bottom end that presents a rim 48 and a central portion 57 in the form of a thimble with its concave side facing towards the top container 42.

While the components A and B are being stored separately, the plug 46 is placed in the constricted portion 49.

The top container 42 has a bellows 14 identical to that described above.

The bellows 14 is connected to the constricted portion 49 via a transverse wall 55 defining a second bearing surface 56 in the meaning of the invention.

An annular flat 50 is formed at the junction between the constricted portion 49 and the bottom container 41.

The rim 48 bears against this flat 50 when the plug 46 is in place.

The endpiece 43 differs from the above-described endpiece 17 in that it does not include a rod 26.

The bottom container 41 can be filled via the sleeve 44 with the plug 46 already being in place.

To expel the plug 46, the bellows 14 of the top container 42 is compressed axially, so that the extra pressure ejects the plug 46 into the bottom container 41.

The device 40 is used in the same manner as the above-described device 1.

The device 60 shown in FIG. 7 differs from that described with reference to FIG. 6 solely in the dispenser endpiece it uses, which is given the reference 70.

The endpiece 70 has an assembly skirt 18 suitable for screwing onto the neck 16 of the top container 42.

The assembly skirt 18 is extended upwards by a conical portion 61 on the axis X which runs into a top wall 68 and a duct 64 defining an outlet channel 65 on an axis Z, where the axis Z intersects the axis X and is nearly perpendicular thereto.

The duct 64 is closed by a removable cap 66.

The top wall 68 defines a first bearing surface 73 in the meaning of the invention.

The endpiece 70 has a longitudinally-split rod 71 on the axis X for exerting pressure on the plug 46 so as to move it out of its position when the bellows 14 is compressed.

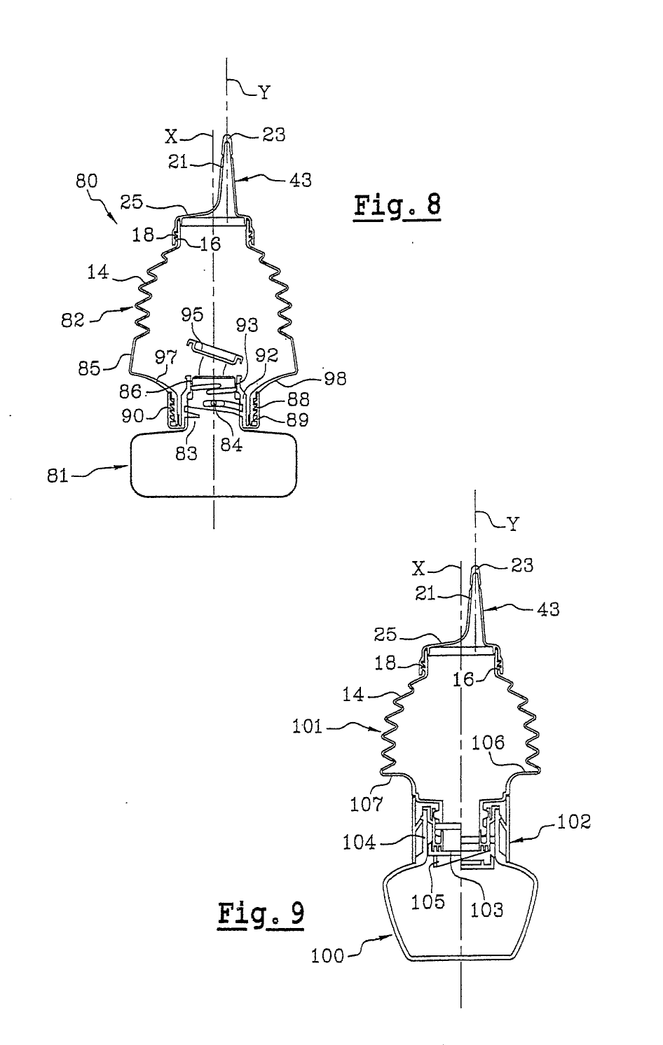

The device 80 shown in FIG. 8 is made by assembling together two containers 81 and 82 that are fitted one in the other.

The bottom container 81 has a neck 83 provided with diametrically opposite studs 84.

At its top end, the neck 83 has a circularly cylindrical surface 86 about the axis X.

The top container 82 has a dispenser endpiece 43 of the kind described above and a bellows 14 whose bottom end is connected to a tubular wall 85 which in turn is extended downwards by a transverse wall 97 defining a second bearing surface 98 in the meaning of the invention.

The top container 82 also has a bottom portion including an outwardly threaded sleeve 88 with a junction ring 89 screwed thereon.

This ring 89 has an internally threaded assembly skirt 90 suitable for screwing onto the sleeve 88 and connected to an inner skirt 92 which engages inside the sleeve and which is designed for receiving the neck 83.

The top of the sleeve 88 is connected to the transverse wall 97.

The inner skirt 92 is internally threaded and has an annular sealing lip 93 at its top portion for pressing in leakproof manner against the above-mentioned surface 86.

When the bottom container 81 is turned relative to the top container 82, the studs 84 co-operate with the thread on the inner skirt 92 causing the neck 83 to move axially upwards inside the skirt 92.

A plug 95 is fixed to the top end of the inner skirt 92 and is ejected therefrom by the neck 83 when the bottom container 81 is screwed home into the top container 82.

The device shown in FIG. 9 has a bottom container 100 and a top container 101 suitable for turning relative to each other about the axis X, without moving axially.

A drive element 102 constituted by a separate piece turns together with the top container 101.

This drive element is similar to one of those described in French patent FR-B-2 765 859, to which reference can usefully be made.

The top container 101 has a bellows 14 whose bottom end is connected to a transverse wall 106 defining a second bearing surface 107 in the meaning of the invention.

A plug 103 is mounted in the neck 104 of the bottom container, without being capable of turning relative thereto but being capable of sliding along the axis X.

This plug 103 is moved downwards when the top container 101 is turned relative to the bottom container 100 by means of ramps 105 made on the drive element 102.

In its initial position, the plug 103 prevents the containers 100 and 101 from communicating with each other.

When the containers 100 and 101 have been turned fully, the component contained in the top container 101 can mix with the component contained in the bottom container 100.

The device also has a dispenser endpiece 43 of the kind described above.

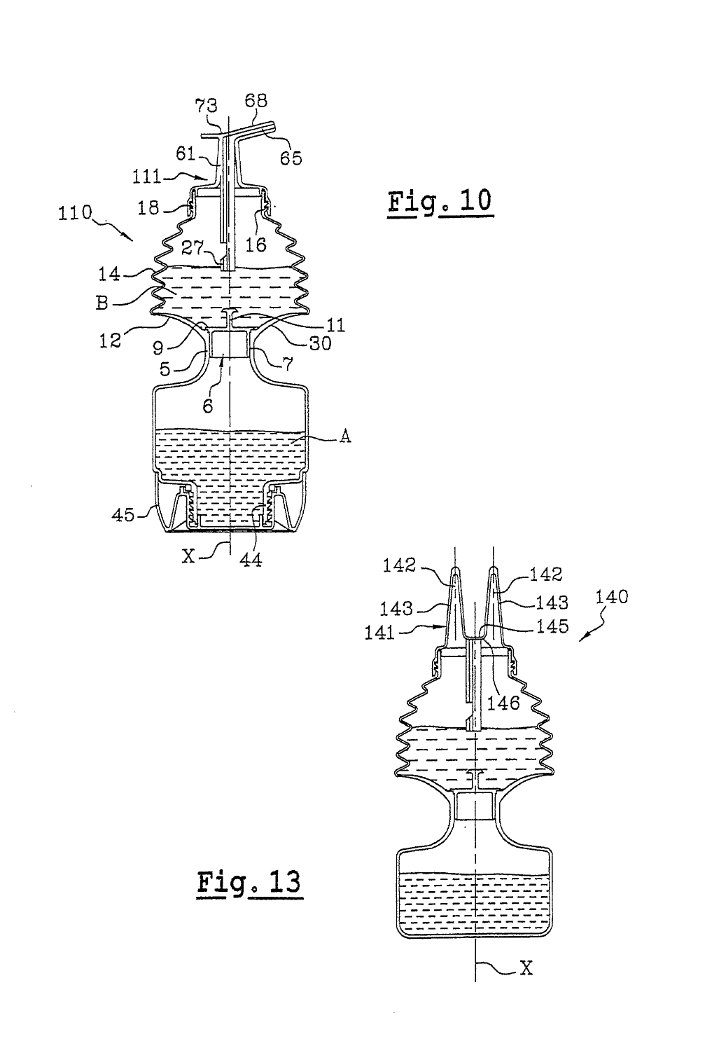

FIG. 10 shows a device 110 which differs from that described with reference to FIGS. 1 to 3 by the fact that the bottom container 3 is replaced by the bottom container 41 of FIG. 6, and by the fact that the dispenser endpiece 17 is replaced by an endpiece 111.

This endpiece 111 is similar to the endpiece 70 of FIG. 7, except that the bottom end of the rod 71 is arranged in a manner similar to the bottom end of the rod 26 so as to couple with the catch 11 on the plug 6.

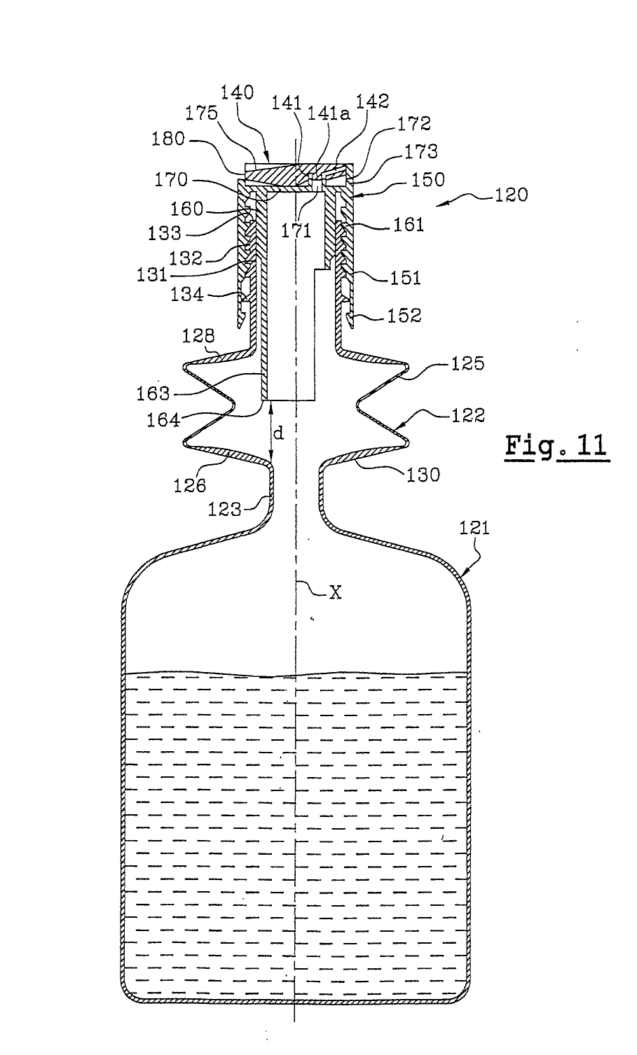

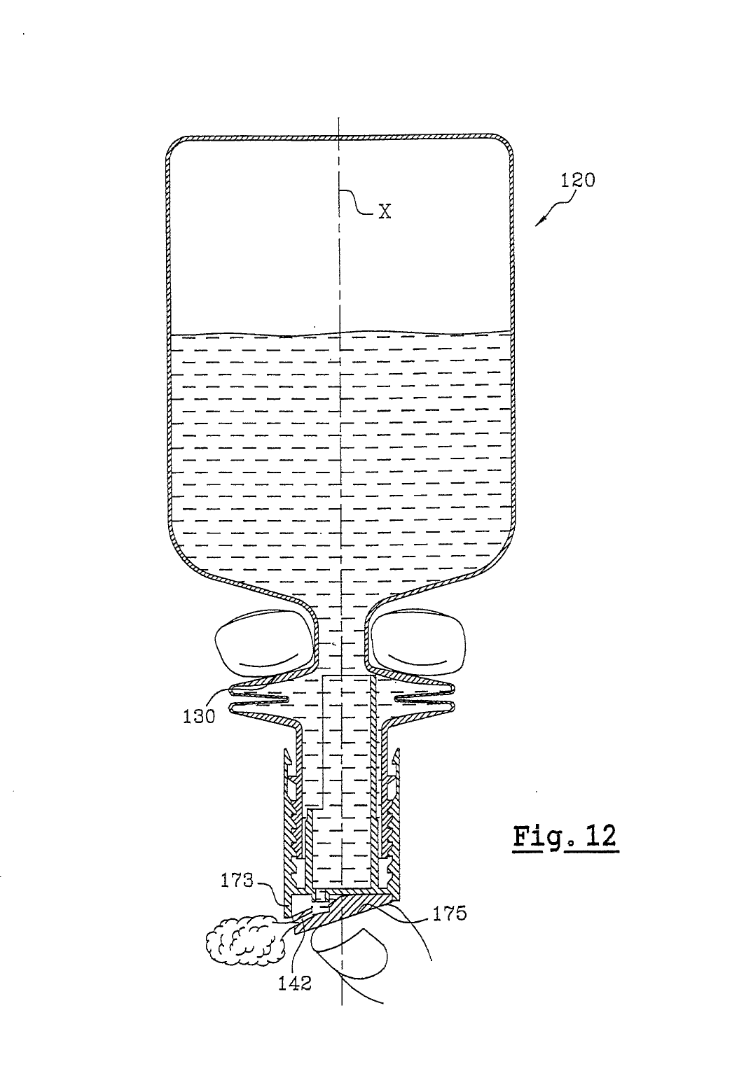

FIGS. 11 and 12 show a device 120 which differs from those described above in particular by the fact that it contains a single substance and not two components for mixing together on first use.

The device 120 comprises a bottom container 121 and a top container 122 interconnected by a constricted portion 123.

The top container 122 has a bellows 125 which is connected to a transverse wall 126 extending the top of the constricted portion 123 and defining a second bearing surface 130 in the meaning of the invention.

The bellows 125 is connected at its top end to a transverse wall 128 which is extended upwards by a neck 131 having an outside thread 132 extending over about half its length from its top end 133.

The neck 131 also has an annular bead 134 beneath the thread 132 and serving a function that is described below.

The device 120 has a dispenser endpiece 140 mounted on an adjustment piece 150 which makes it possible at will to modify the compression stroke of the bellows 125 so as to dispense a smaller or larger quantity of substance on each use.

The adjustment piece 150 has an outer skirt 151 arranged to screw onto the thread 132 and provided at its bottom end with a bead 152 suitable for passing over the above-mentioned bead 134 by elastic deformation, and substantially preventing the outer skirt 151 from being completely unscrewed, the bead 152 coming to bear against the bead 134.

The adjustment piece 150 also has an inner skirt 160 comprising a top portion 161 arranged to bear in leakproof manner against the radially inner surface of the neck 131 and a bottom portion 163 with longitudinal perforations, having a bottom end 164 suitable for bearing against the transverse wall 126 when the bellows 125 is compressed.

The outer and inner skirts 151 and 160 are connected to each other via a transverse wall 170 which includes an orifice 171 through which substance is delivered, and is surrounded by an annular lip 172 about an axis parallel to the axis X of the receptacle.

The endpiece 140 includes a housing 141 in which the annular lip 172 is received, said housing 141 communicating with an outlet channel 142 for dispensing the substance.

This outlet channel 142 opens out in the side surface of the endpiece 140.

A stud 141a projects into the end of the housing 141 to close the passage defined by the annular lip 172 when the endpiece is in its closed position.

Above the transverse wall 170, the adjustment piece 150 has a peripheral wall 173 about the axis X, provided with an opening 180 on its side opposite from the outlet channel 142 so as to enable the user to press with the thumb against a bearing surface 175 defined by the endpiece 140 beside said opening.

The endpiece 140 is hinged to the peripheral wall 173 so that when the user presses on the surface 175, which surface constitutes a first bearing surface in the meaning of the invention, the endpiece 140 tilts and the outlet channel 142 takes up a position above the peripheral wall 173, as shown in FIG. 12.

It will be understood that by tightening the adjustment piece 150 to a greater or lesser extent on the neck 131, the distance d between the bottom end 164 of the inner skirt 163 and the transverse wall 126 is adjusted, thus modifying the axial compression stroke of the bellows 125.

The neck 131 can have external graduations so as to enable the user to position the adjustment piece 150 accurately relative to the neck 131.

Naturally, the invention is not limited to the embodiments described above.

In particular, the device can contain more than two components.

The compressible portion of the receptacle can be formed by a deformable wall that is shaped other than as a bellows.

The device of the invention can also have compression means enabling a pressure exerted on the axis of the receptacle in two opposite directions to be transformed into pressure in a different direction relative to the receptacle.

The dispenser endpiece can be given shapes other than those shown in the drawings.

By way of example, FIG. 13 is an axial section view of a device 140 which differs from that shown in FIG. 1 by the fact that the endpiece 17 has been replaced by an endpiece 141 which has two dispenser channels 142 , each defined by a respective conical portion 143.

The endpiece 141 has a rod 26 and tabs 27.

The region of the wall 146 of the endpiece situated on the axis X of the receptacle between the two conical portions 143 serves as the first bearing surface 145.

The spacing between the two conical portions 143 is sufficient to enable the user to press against the endpiece 141 with the thumb.

The two conical portions 143 can act like a comb when the endpiece is brought into contact with or into the vicinity of the scalp.

1/ A device for packaging and applying a substance, the device comprising a receptacle having a compressible portion and a dispenser endpiece, the device including first and second bearing surfaces situated respectively at opposite ends of the compressible portion so as to enable a user to exert pressure along the axis of the receptacle to move said bearing surfaces towards each other and compress the compressible portion, the first bearing surface being situated on the endpiece or close thereto, so that the user can dispense the substance by holding the device in one hand and bringing that hand into contact with the surface onto which the substance is to be applied.

2/ A device according to claim 1, wherein the compressible portion comprises a bellows.

3/ A device according to claim 2, wherein the second bearing surface is defined by a transverse wall to which the bellows is connected.

4/ A device according to claim 1, wherein the second bearing surface is formed around a constricted portion of the receptacle defining an annular waist in which the middle and index fingers can be placed during use.

5/ A device according to claim 1, including a removable plug disposed in such a manner as to form two compartments, each containing one component.

6/ A device according to claim 5, including activation means enabling the plug to be moved on first use so as to enable the components to mix together.

7/ A device according to claim 6, wherein the activation means comprise a rod secured to the dispenser endpiece.

8/ A device according to claim 4, wherein the activation means comprise a rod secured to the dispenser endpiece, and wherein the rod is arranged to exert thrust on the plug, and wherein the plug is placed in the constricted portion of the receptacle so as to be move out therefrom by thrust exerted by the rod.

9/ A device according to claim 4, wherein the activation means comprise a rod secured to the dispenser endpiece, and wherein the rod is provided with coupling means suitable for snap-fastening on relief on the plug when the rod is moved towards it, and wherein the plug is placed in the constricted portion of the receptacle in such a manner as to be moved out therefrom by traction exerted by the rod.

10/ A device according to claim 5, wherein the receptacle is formed by assembling together two containers, one container having a sleeve and the other having a neck suitable for engaging in said sleeve, the plug being positioned therein in such a manner as to be ejected when the two containers are assembled together.

11/ A device according to claim 4, including a removable plug disposed in such a manner as to form two compartments, each containing one component, and wherein the plug is placed in the constricted portion in such a manner as to be ejected by an increase of pressure created inside the receptacle by the compressible portion being deformed.

12/ A device according to claim 5, wherein the receptacle is constituted by two containers assembled together so as to be capable of turning relative to each other, and by the fact the device is arranged in such a manner that turning one of the containers relative to the other causes the plug to be moved and the containers to be put into communication with other.

13/ A device according to claim 1, wherein the endpiece includes a break-off portion.

14/ A device according to claim 1, wherein the endpiece includes an outlet channel that is off-center, and wherein the first bearing surface intersects on the axis of the receptacle.

15/ A device according to claim 14, wherein the outlet channel opens to the outside in a direction that is substantially parallel to the axis of the receptacle.

16/ A device according to claim 14, wherein the outlet channel opens to the outside in a direction that is substantially perpendicular to the axis of the receptacle.

17/ A device according to claim 1, including an adjustment member enabling the compression stroke of the compressible portion to be modified depending on the quantity of substance that is to be dispensed.

18/ A device according to claim 17, wherein the dispenser endpiece is carried by the adjustment member.

19/ A device according to claim 18, wherein the dispenser endpiece is hinged on the adjustment member, and wherein the adjustment member includes a peripheral wall enabling the outlet orifice of the endpiece to be masked when the endpiece is in a first position relative to the adjustment member, the endpiece being capable of taking up a second position in which the outlet orifice is not masked by the peripheral wall when the user presses on the first bearing surface.

20/ A device according to claim 19, wherein the adjustment member has an outlet orifice surrounded by an annular lip engaging in a housing of the endpiece.

21/ A device according to claim 17, wherein the adjustment member is fixed in adjustable manner on the neck of the receptacle.

22/ A device according to claim 1, wherein the endpiece has a plurality of outlet channels.

23/ A device according to claim 22, wherein the endpiece has a wall defining the first bearing surface and situated on the axis of the receptacle.

24/ The use of a device according to claim 1 with the dispenser endpiece pointing downwards.

25/ The use of a device according to claim 1, with pressure against the first bearing surface being applied with the thumb and pressure against the second bearing surface being applied by the middle and index fingers.

26/ A use according to claim 25, in which the middle and index fingers are placed on either side of a constricted portion of the receptacle.

27/ The use of a device according to claim 1 to apply a substance to the hair and/or to the scalp.

28/ A device for packaging and applying a substance, the device comprising a receptacle having a compressible portion and a dispenser endpiece, the device including first and second surfaces situated respectively at opposite ends of the compressible portion so as to enable a user to exert pressure along the axis of the receptacle to move said surfaces towards each other and compress the compressible portion, wherein the endpiece includes an outlet channel that is off-center and has an axis that is substantially parallel to the axis of the receptacle, and wherein the first surface intersects on the axis of the receptacle.
